(19) United States
(12) Patent Application Publication
(10) Pub. No.: US 2019/0126551 A1
(43) Pub. Date: May 2, 2019

(54) ADDITIVE MANUFACTURING POWDER DISTRIBUTION

(71) Applicant: HEWLETT-PACKARD DEVELOPMENT COMPANY, L.P., Houston, TX (US)

(72) Inventors: Joan CAMPDERROS CANAS, Sant Cugat del Valles (ES); Marta TUA SARDA, Sant Cugat del Valles (ES); Gonzalo GASTON LLADO, Sant Cugat del Valles (ES); Josep TENAS GARCIA, Sant Cugat del Valles (ES); Sergio VILLAR GARCIA, Sant Cugat del Valles (ES)

(73) Assignee: HEWLETT-PACKARD DEVELOPMENT COMPANY, L.P., Houston, TX (US)

(21) Appl. No.: 16/089,092

(22) PCT Filed: Aug. 31, 2016
(86) PCT No.: PCT/US2016/049738

§ 371 Date: Sep. 27, 2018

(51) Int. Cl. B29C 64/329; B29C 64/165; B29C 64/205; B22F 3/105; B29C 64/153; B33Y 10/00; B33Y 30/00; B22F 3/00

(52) U.S. Cl. CPC B29C 64/329; B29C 64/165; B29C 64/205; B22F 3/1055; B22F 2003/1056; B33Y 10/00; B33Y 30/00; B22F 3/008; B29C 64/153

(57) ABSTRACT

Powder distribution in additive manufacturing may include systems or methods to distribute powder from an intermediate buffer or reservoir while scanning over a stage with the buffer or reservoir.

### BACKGROUND

One additive manufacturing technique involves building objects in a powder bed, whereby powder layers are disposed over a build stage and selective patterns within the powder layers are fused to build the objects layer-by-layer. It can be challenging to distribute powder layers having a relatively constant surface over the surface of the stage. One technique of powder distribution involves laying an excess amount of powder near a side of the stage and then using a flattening roller to spread the powder from the side over the rest of the stage.

### DRAWINGS

FIG. 1 illustrates a diagram of an example of a powder distribution system for an additive manufacturing apparatus;

FIG. 2 illustrates a diagram of another example of a powder distribution system in a first condition;

FIG. 3 illustrates a diagram of the example powder distribution system of FIG. 2 in a second condition;

FIG. 4 illustrates a diagram of the example powder distribution system of FIGS. 2 and 3 in a third condition;

FIG. 5 illustrates a diagram of an example of a bottom structure for an intermediate powder buffer;

FIG. 6 illustrates a diagram of the example bottom structure of FIG. 5 wherein a first hole array is shut with a shutter;

FIG. 7 illustrates a diagram of the example bottom structure of FIGS. 5 and 6 wherein a second hole array different than the first hole array is shut with a shutter;

FIG. 8 illustrates a diagram of an example of an additive manufacturing sub-system including an example powder distribution system;

FIGS. 9 and 9A illustrate examples of profiles of an outer surface of a roller;

FIG. 10 illustrates an example of a distributed powder layer having a first thickness;

FIG. 11 illustrates an example of a distributed powder layer having a second thickness;

FIG. 12 illustrates a flow chart of an example of a method of distributing layers of powder over a stage; and

FIG. 13 illustrates a flow chart of another example of a method of distributing layers of powder over a stage.

### DESCRIPTION

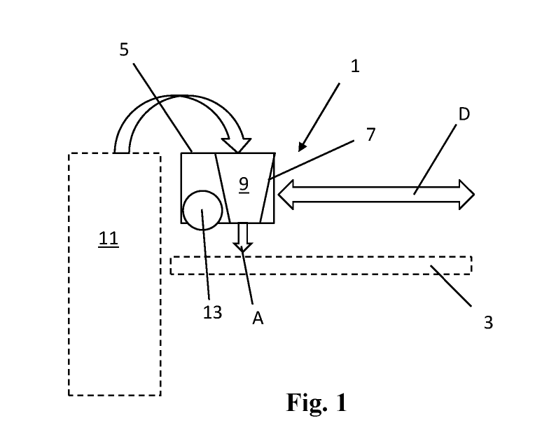

FIG. 1 illustrates a diagram of an example of a powder distribution system 1 for an additive manufacturing apparatus. Further components of an additive manufacturing apparatus are drawn in dotted lines. The additive manufacturing apparatus may be a three-dimensional (3D) printer. The additive manufacturing apparatus may be to print an object in a powder bed wherein layers of powder are stacked and patterned to build the object. In this disclosure the terms “building”, “printing” and “additive manufacturing” all refer to building an object on a stage. Powder of each layer may be fused in predefined patterns, or at least partly melted and/or solidified in any preferred manner, to form a final object in stacked powder layers. In one example energy is emitted onto the powder to facilitate fusion of the powder. The energy may be any energy that can be absorbed by the powder to induce a phase change, e.g. to at least partially fuse or melt the powder. In a further example the energy includes heat, for example using infrared (IR) waves. Another example uses ultraviolet (UV) polymerization. In a further example agent can be printed in said patterns onto the powder to further assist in fusing the powder.

In another example, an agent, for example a binding agent, is deposited on the powder to bind the powder. In again a further example a combination of fuse agents and irradiation is used to fuse predefined patterns in layers in powder, to build an object in the powder bed. One example of such combined additive manufacturing process can be referred to as Multi Jet Fusion®.

FIG. 1 illustrates a powder distribution system 1 and other parts of an additive manufacturing apparatus. The other parts include a build stage 3 for stacking powder layers and building objects, and a powder delivery system 11 to deliver powder, for example as received from an external, e.g., replaceable, powder supply, to the powder distribution system 1. The stage 3 may extend below the powder distribution system 1, at least during printing. A powder bed may be formed onto the stage 3 by distributing layers of powder using the powder distribution system 1. A first layer may be disposed directly onto the stage surface while subsequent layers will be stacked on previously disposed powder layers. The stacked layers may be referred to as powder bed.

Perhaps redundantly it is mentioned that, in this disclosure, when referring to distributing powder over a stage 3 this includes distributing powder both over a stage and over a powder bed. In this disclosure when referring to scanning over a stage 3 this includes scanning over a stage and over a powder bed, etc.

Powder particles for additive manufacturing may be of any suitable material and of any suitable average particle size. In certain examples, the powder particles have average diameters of between approximately 10 and 200 micron, for example between approximately 20 and 100 micron, for example 20 to 50 micron. In further examples, average layer thicknesses may vary, that is, an average layer thickness may be chosen by adjusting the powder distribution system 1, for which certain mechanisms may be provided that will be discussed later in this disclosure. An average powder layer thickness can for example be between approximately 20 and 200 micron, between approximately 30 and 120 micron, for example approximately 80 micron. It is mentioned that once parts of a previously deposited layer are fused (and/or bound and/or solidified), these parts may shrink or expand. In this disclosure we will discuss fused portions that shrink but similar principles would apply to examples where fused portions expand. In any event, such previous layer does not have a constant thickness or layer surface after partially fusing the layer. Hence, to obtain a relatively constant layer surface over a previous, partially fused layer, the subsequent powder layer would ideally be distributed so that it is thicker/thinner over the fused portions to compensate for the thickness variations. Regions of the new powder layer that lie over unsolidified previous layer portions may still have a relatively constant thickness.

In this disclosure, a “constant”, “uniform” or “regular” layer surface refers to a flatness or profile of the top surface of the powder layer. In one example of such constant, uniform or regular layer surface, the layer surface is flat and parallel to the stage surface. In another example of such constant, uniform or regular layer surface, the layer surface has a profile, for example an undulated or ridged surface profile, wherein the profile is regular over the surface of the layer.

The powder distribution system 1 includes a carriage 5. The carriage 5 is to scan over the stage 3 to distribute the powder. The carriage 5 may be arranged to scan parallel to the stage 3 in two opposite directions D, for example using guide rails, wheels or slides, and an electromotor. The carriage 5 has mounted thereon an intermediate powder buffer 7. The intermedia powder buffer 7 is to receive powder from a powder delivery system 11 and store the powder in its reservoir 9. The intermediate powder buffer 7 is called “intermediate” because it is placed between the powder supply system 11 and the stage 3, temporarily buffering the powder during scanning before dispensing it on the stage 3. The intermediate powder buffer 7 may henceforward simply be referred to as buffer 7. The buffer 7 includes a reservoir 9 to store powder. During printing the at least partially filled reservoir 9 scans over the stage 3 whereby the powder is dispensed out of the reservoir 9 and distributed over the stage 3, as indicated with arrow A.

The powder distribution system 1 includes a distributor 13 to distribute the powder over the stage 3. The distributor 13 is mounted to the carriage 5. The distributor 13 scans together with the carriage 5 and buffer 7 during powder dispensing. The distributor 13 spreads and flattens the powder after it has been dispensed from the reservoir 9. The distributor 13 may include a roller or squeegee or both. The powder can be directly dispensed from the buffer 7 onto the stage 3 and subsequently distributed by the distributor 13, or the buffer 7 may dispense the powder onto or next to the distributor 13 so that the distributor 13 directly distributes the powder on the stage 3.

The disclosed powder distribution system 1 with intermediate buffer 7 may allow for relatively controlled dosing and distribution of powder over the stage area, through which a relatively uniform powder layer thickness, or at least a relatively uniform powder layer surface, can be achieved over the entire surface of the stage 3. As a result of the uniform layer surface, relatively predictable material and mechanical properties of printed objects can be achieved. As an additional result, measured amounts of powder can be contained in the buffer 7, so that a relatively low amount of excess powder is required before each carriage pass, which may in turn lead to less waste and less airborne powder.

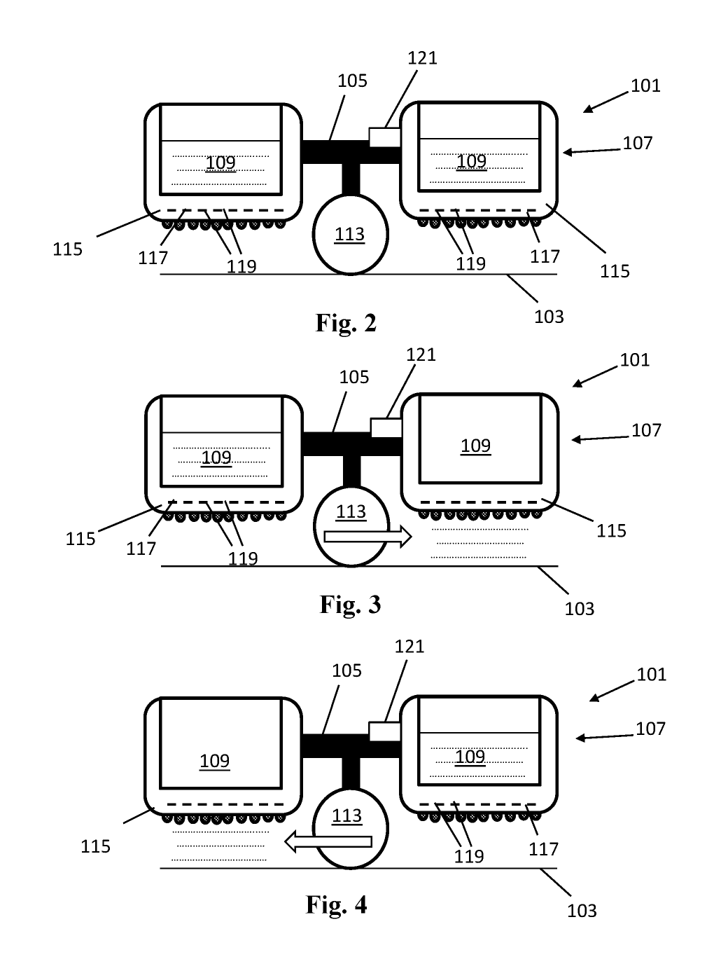

FIGS. 2-4 illustrate another example powder distribution system 101, for an additive manufacturing system, in different instances in an additive manufacturing process. The system 101 includes a carriage 105 to scan over a stage 103. The carriage 105 has mounted thereon a powder buffer 107 and distributor 113. In this example, the distributor 113 includes a flattening roller. The powder buffer 107 has two reservoirs 109 to store powder for dispensing, extending on opposite sides of the distributor 113. Bottoms of the reservoirs 109 include plates 115 with hole arrays 117 that are to allow powder to pass through holes 119 towards the stage. Each reservoir 109 may include one or a plurality of hole array plates 115. The holes 119 of the arrays 117 and the scanning speed may be calibrated to control powder dispensing and powder layer thickness.

A shaker element 121 can be mounted to the carriage 105, or to the buffer 107, or to each reservoir 109, or to each hole array plate 115. The shake element 121 may provide for vibration at a suitable frequency to facilitate sieving of the powder through the hole array 117. The shake element 121 may assist in providing a relatively constant powder flow through the hole array 117 during the carriage scanning. In one example only the hole array plate 115 shakes to assist in sieving. In another example the entire reservoirs 109 shake which may assist in loosening the powder in the reservoir 109 as well as sieving. In yet another example, the shake element 121 includes at least one electro-motor and an eccentric transmission connected to a shaft of the motor and to the reservoir 109. In such example, when the motor rotates, the transmission shakes the reservoir 109. In another example a linear motion is induced to the reservoir 109 and/or to the array plate 115, for example by means of an electromotor that includes a transmission for translating a rotating motor to a linear back-and-forth motion. Various other types of shake elements 121 can also be suitable.

In the instance of FIG. 2, both reservoirs 109 have been filled with powder by a powder delivery system. In the instance of FIG. 2 the powder distribution system 101 is about to distribute a layer of powder over the stage 103 in a first pass.

In the instance of FIG. 3, the carriage 105 scans over the stage 103 towards the right, for example during a first pass for providing a first powder layer, while the powder distribution system 101 distributes a layer of powder over the stage 103. The right reservoir 19 dispenses its powder onto the stage 103, through the hole array 117. The powder is dispensed at the right side of the distributor 113, downstream of the movement direction. In the same scanning movement, the distributor 113 flattens the powder that is dispensed in front of it, thereby further spreading the powder. The consequent scanning, dispensing and flattening provides for a relatively constant powder layer surface over the stage surface. One carriage scanning movement covers the entire stage whereby the quantity of powder in each reservoir 109 can be approximately the same as the build stage surface area, that is, the surface area of the stage that is used to build, times the intended layer thickness, plus a chosen relatively small margin such as for example 1-20% of extra powder.

In the instance of FIG. 4 the carriage 105 scans in the opposite direction of the scanning direction of FIG. 3, for example in a second pass for providing a second powder layer that follows the first layer. In the illustration the carriage 105 scans toward the left. This time the left reservoir 19 dispenses its powder onto the stage 103, through the hole array 117. The powder is dispensed at the left side of the distributor 113, downstream of the movement direction. Again, in the same scanning movement, the distributor 113 flattens the powder that is dispensed in front of it, thereby further spreading the powder. The left reservoir 109 may have been filled before making the scanning movement of FIG. 3, that is, first the left reservoir 109 was filled, then a complete scanning pass has completed while emptying the other reservoir 109, and then the left reservoir 109 is substantially emptied over the stage. The opposite, right side, reservoir 109 may be filled on the right side of the stage while the left reservoir 109 may be filled on the left side of the stage, with each filling occurring between subsequent opposite passes. In other examples, the reservoir 109 could be filled every two or four passes whereby the reservoir 109 contains a powder quantity of multiple layers. In other examples both reservoirs 109 are filled at the same lateral side of the stage.

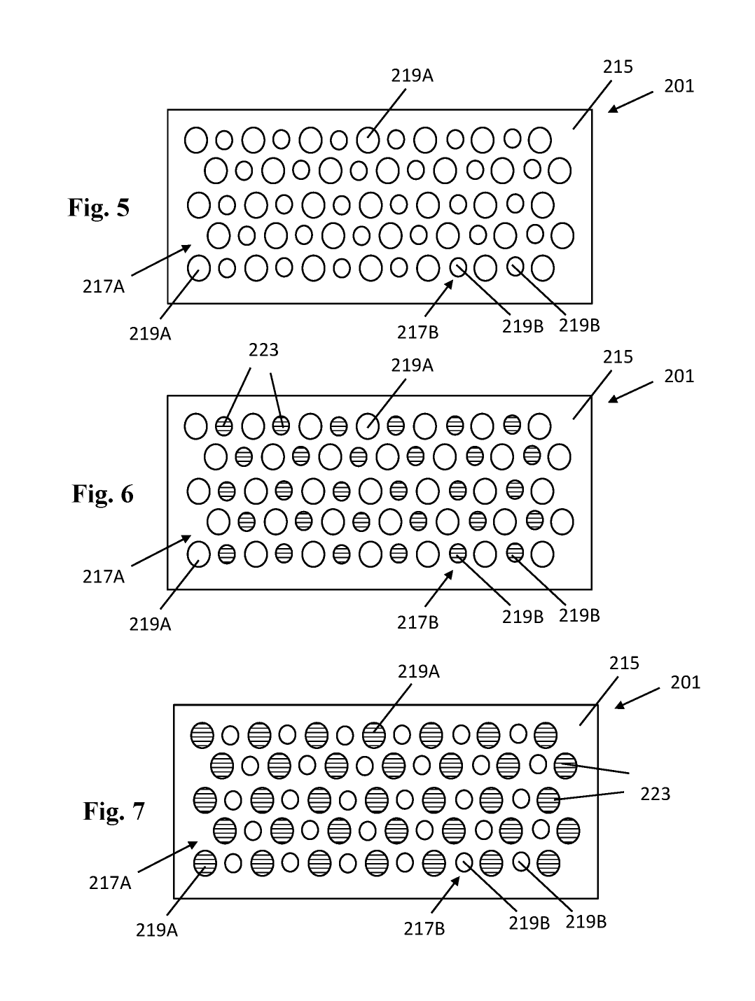

FIGS. 5-7 illustrate a hole array plate assembly 215 with a plurality of hole arrays 217A, B. The hole array plate assembly 215 may form at least part of a reservoir bottom of a buffer reservoir of a powder distribution system of this disclosure. A first hole array 217A includes first holes 219A of a first diameter. A second hole array 217B includes second holes 219B of a second diameter different than the first diameter, for example smaller than the first diameter. For example the first array 217A has larger hole diameters than the second array 217B. FIG. 6 illustrates a first instance of the hole array plate 215 where the second holes 219B are closed and the first holes 219A are open. FIG. 7 illustrates a second instance of the hole array plate 215 where the first holes 219A are closed and the second holes 219B are open. The first instance of FIG. 6 allows for a relatively higher powder flow rate through the plate 215, thereby providing for a thicker powder layer than the second instance with the same carriage speed.

A shutter 223 can be used to shut holes of the respective hole array while keeping holes of the other hole array open. The shutter 223 may slide or move with respect to the hole array plate 215 for closing the respective holes. In one example a shutter plate extends at the bottom of the hole array plate 215, e.g., opposite to the reservoir to allow for sliding with limited interfering with powder particles. In other examples variable hole diameters can be obtained by different mechanisms. For example the holes may be formed by diaphragms, such as sometimes used in optics such as camera lenses, whereby the diaphragm provides for a contour of the hole and allows for expanding or contracting the hole contour, thereby varying a hole size of each hole or a subset of holes. Also as little as two plates with overlapping holes can slide with respect to each other to facilitate widening and narrowing of holes by having less or more overlap. Different mechanisms may be used to achieve different hole sizes whereby a surface area of the hole may be chosen according to a desired layer thickness and/or print mode.

In another example a hole array plate may include a mechanism that allows for setting the amount of holes that are open or shut, for example using a shutter. In again another example instead of varying a surface area or amount of holes, a carriage scanning speed may be adjusted to set a layer thickness. For example a lower scanning speed may result in averagely thicker layers and a higher speed in averagely thinner layers.

In one example a holes sizes can be chosen for each print job. For example relatively large holes can be chosen for a draft print mode and relatively small hole sizes can be chosen for a relatively high quality print mode. In another example the hole sizes can be varied within the print job, for example between layers or layer-sets. This could allow for different finishing of different parts of an object. In again a further example hole sizes can be varied within a single layer pass to vary powder flow and thickness within the layer, for example to compensate for varying thicknesses in a previous layer, for example as a result of fusing and/or solidification.

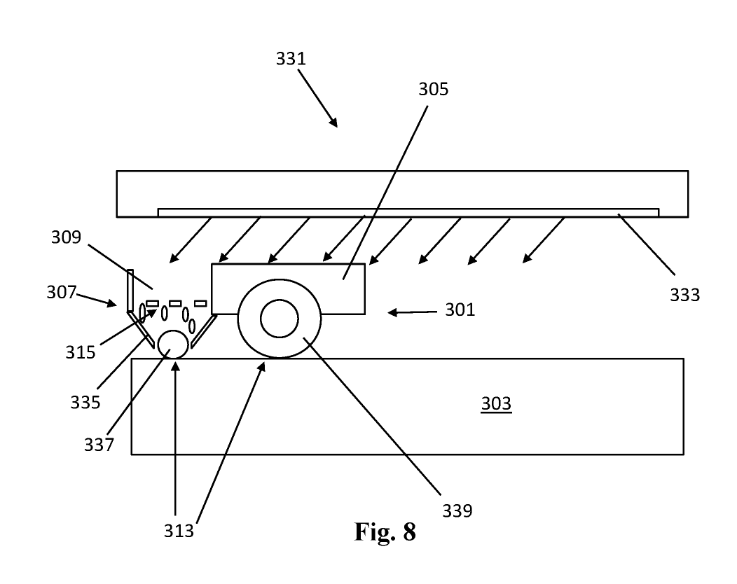

FIG. 8 illustrates an example of a sub-system 331 of an additive manufacturing apparatus. The sub-system 331 includes a powder distribution system 301. During printing, a powder bed 303 may lie on a stage vertically under the powder distribution system 301. The sub-system 331 further includes an irradiation structure 333 to emit heat and/or light of a predetermined wavelength range onto the powder bed, for example to facilitate fusing of object patterns in the powder layers. In one example the irradiation structure 333 includes an IR irradiation source.

The powder distribution system 301 includes a carriage 305. The carriage 305 scans along a carriage rail (not shown) over the stage. The powder distribution system 301 further includes a powder buffer 307 and two distributors 313, mounted to the carriage 305 to scan over the stage. One of the distributors 313 extends at the bottom of the buffer 307. The buffer 307 provides the powder directly to that distributor 313 that distributes to the powder over the stage. The other distributor 313 is used to flatten the distributed powder over the stage surface.

The powder buffer 307 includes a powder reservoir 309. The powder buffer 307 includes a hole array plate 315 at the bottom of the reservoir 309. The hole array allows powder in the reservoir 309 to pass through towards the distributor 313. The buffer 307 may include a secondary reservoir 335, guide plates, funnel or the like to guide sieved powder towards the distributor 313.

The hole array plate 315 may include a mechanism to reconfigure a surface area of the holes. For example the hole array plate 315 may include different hole arrays and a shutter similar to FIGS. 5-7, or the hole array plate 315 may include other hole size resetting mechanisms such as diaphragms.

The distributor 313 under the buffer is a roller 337, hereafter named distributor roller 337. The distributor roller 337 is to roll during carriage scanning whereby the rolling movement of the distributor roller 337 distributes the powder over the stage. The outer surface of the roller 337 may be ridged/grooved, wherein the ridges extend parallel to the axle of the roller. Powder may be transported between the ridges, for example in grooves between the ridges. The ridges may aid in an even distribution of powder to obtain for a relatively even layer thickness over the surface of the stage. In another example, the ridges may aid in allowing powder to pass through between the secondary reservoir 335, guide plates, funnel or the like and the distributor roller 337. In again a further example the ridged roller surface profile results in a ridged layer surface profile. A ridged layer surface profile increases the layer surface as compared to a flat layer surface. Hence, more powder layer surface is directly exposed to radiation. This may allow for better pre-heating of the powder layer.

A second distributor may also be a roller, hereafter named flattening roller 339. The flattening roller 339 is mounted to the carriage 305, to flatten the powder after it has been distributed by the distributor roller 337. In the illustrated example, the powder distribution system is such that the distributor roller 337 leads and the flattening roller 339 trails, as said, to flatten the powder surface after the powder layer has been distributed by the distributor roller 337. An additional, mirrored buffer and associated distributor roller can be mounted to the carriage 305. The additional buffer and associated distributor roller can be mounted to the opposite side of the carrier 305 with respect to the illustrated buffer 307 and distributor roller 337, so that the distribution system 301 may scan and distribute powder in opposite directions, similar to FIGS. 2-4.

In another example, instead of a flattening roller, another flattening structure could be used such as a squeegee. In yet another example the distributor roller 337 itself provides for a final distribution and flattening of the powder whereby no additional flattening roller or structure is provided. For example it may be desired to maintain a ridged or undulated layer surface profile, so that flattening is omitted or limited.

In one example, the irradiation structure 333 is provided to heat the powder bed 303 to facilitate fusing. The irradiation structure 333 may emit IR radiation, for example using IR lamps or LEDs. During printing, the carriage 305 and associated distribution system 301 scans under the irradiation structure 333. Hence, during scanning, powder in the reservoir 309 is heated by the irradiation structure 333. As a result, the powder is pre-heated before it is dispensed on the powder bed 303. Such pre-heating by the irradiation structure 333 may provide for a more efficient use of energy in the additive manufacturing apparatus and/or relatively fast fusing.

In other examples, other preheater elements can be used to pre-heat powder in the intermediate buffer. For example, the buffer may be equipped with pre-heater elements. For example portions of the reservoir 309, hole array plate 315 and/or distributor 313 may include pre-heater elements such as heat wiring, heat fins, etc.

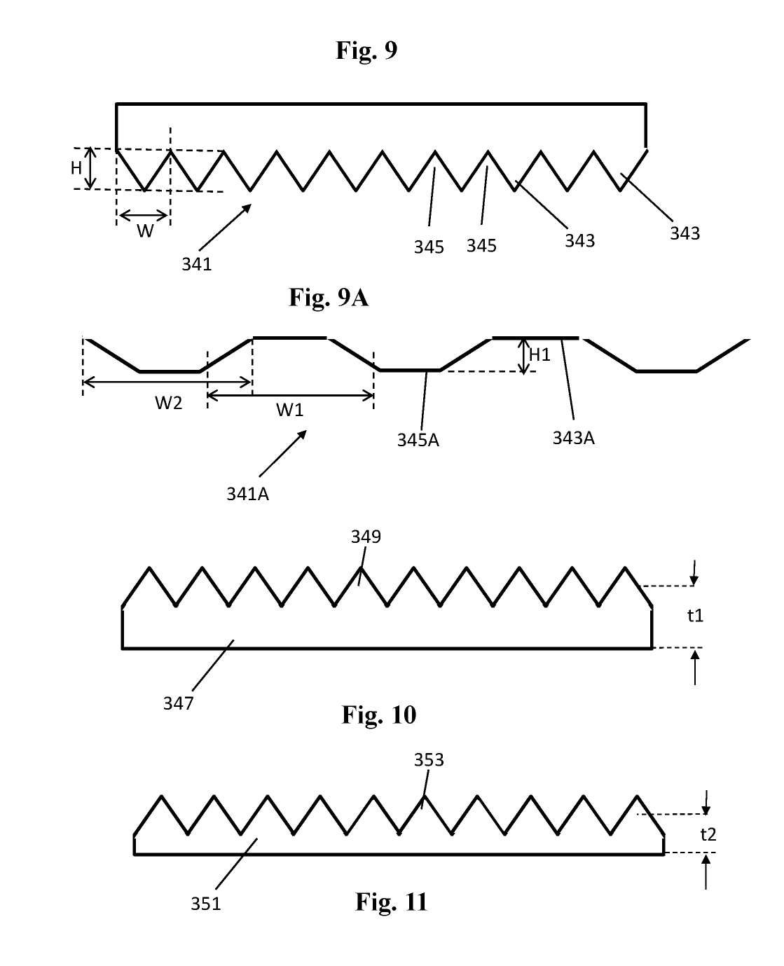

FIG. 9 illustrates a diagram of a distributor roller surface 341. A surface profile of the distributor roller surface 341 includes ridges 343 and grooves 345. The surface profile may include metal such as stainless steel. The saw-tooth profile is for illustrative purposes only. Other profiles, such as the one illustrated in FIG. 9A, may also be suitable and may similarly include ridges 343A and grooves 345A. In one example, a distributor roller may have a diameter of approximately 2 to 50 millimeter. The ridges 343 and/or grooves 345 of the roller have a height H and/or width W of between approximately 20 and 1000 microns. In one example the height H and/or width W of the ridges 343 and/or grooves 345 is approximately 0.2 millimeters, which may be suitable for creating powder layers of approximately 0.1 millimeter thick in one pass. Herein the height H may be measured between the lowest point of the grooves 345 and the highest point of the ridges 343. The width W may be the width W of the groove 345 between the lateral peaks, as determined by the ridges 343 on either side of the groove 345, or the width W of the ridge 343 between the lateral lowest points, as determined by the grooves 345 on either side of the ridge 343. During operation of the powder distribution system powder is provided to the distributor roller whereby grooves 345 of the roller collect at least part of the powder, and transport it to the powder bed.

FIG. 9A illustrates a diagram of another distributor roller surface 341A. The surface 341A has flattened peaks and bottoms of ridges 343A and grooves 345A, respectively. In one example each of the grooves 345A and ridges 343A may have a width W1, W2, respectively. In one example, each width W1, W2 may be approximately 1 millimeter. In another example, a width W1 of the groove 345A is approximately 1.3 millimeter while a width W2 of the ridge 343A is approximately 0.7 millimeter. The height H of the grooves 345A and ridges 343A may be the same and can be approximately 0.1 millimeter, for example for a 0.5 millimeter layer thickness. Other examples of grooved or ridged roller surface profiles may include rounded or undulated surface profiles, for example sinusoid.

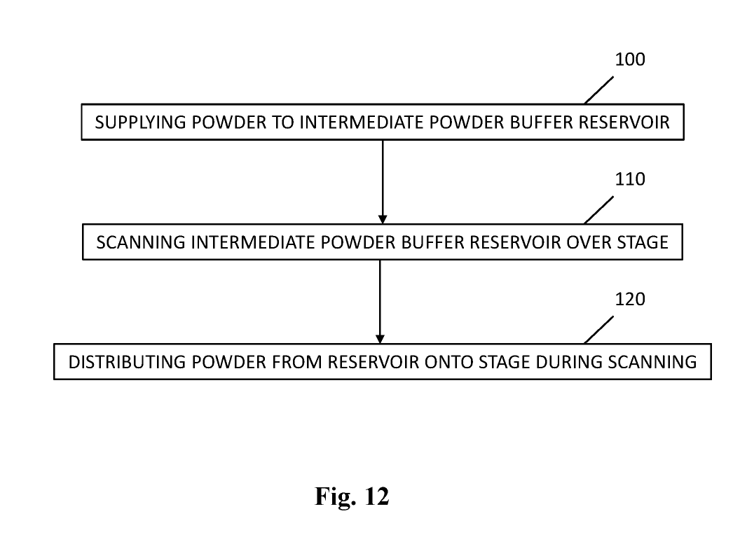

FIG. 10 illustrates a portion of a first powder layer 347 having a first thickness t1. The layer surface may have ridges 349 corresponding to a ridged surface profile of the distribution roller. The indicated thickness t1 of the layer may be a thickness after flattening. FIG. 11 illustrates a portion of a second powder layer 351. The second powder layer may have ridges 353, also because of a ridged surface profile of the distribution roller. The second layer 351 has a second thickness t2 that is less than the first thickness t1. In one example, the first layer 347 may have been dispensed through a first hole array and the second layer 351 may have been dispensed through a second hole array wherein first holes of the first hole array have a larger cumulative surface area than a cumulative surface area of second holes of the second hole array, using the same scanning speed of the powder distribution system. A larger cumulative surface area of holes of a hole array allows for thicker layers, that is, using the same scanning speed of the powder distribution system.

FIG. 12 illustrates a flow chart of an example of a method of distributing powder over a stage. The method may be part of an additive manufacturing process. The method includes supplying powder to an intermediate powder buffer reservoir (block 100). Examples 9, 109, 309 of such reservoir are illustrated in FIGS. 1-4 and 8. The method includes scanning the intermediate powder buffer reservoir over the stage or powder bed (block 110). The method further includes distributing powder from the reservoir onto the stage during such scanning (block 120). The reservoir may be emptied at constant powder flow during scanning over the stage.

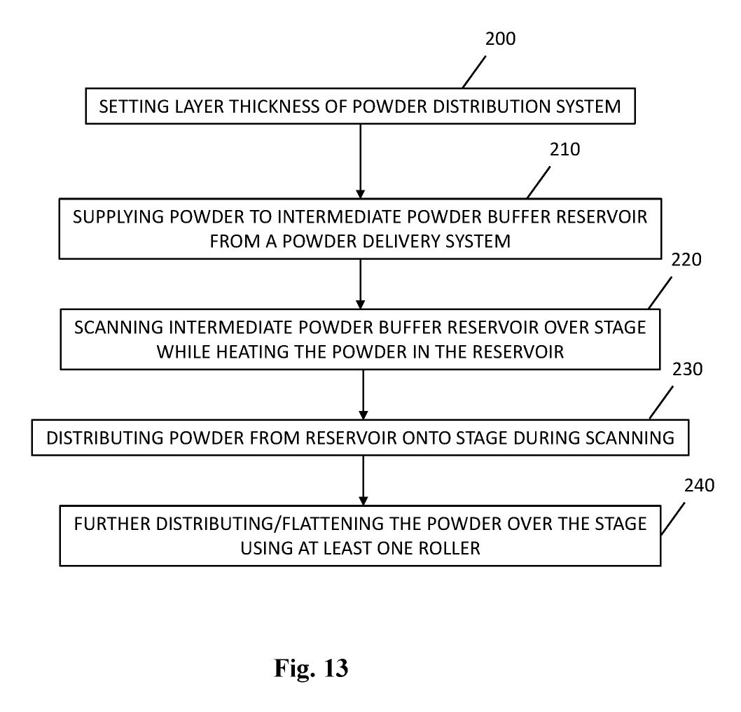

FIG. 13 illustrates a flow chart of another example of a method of distributing powder over a stage. The method may be part of an additive manufacturing process. The method may include setting an average powder layer thickness of an additive manufacturing job (block 200). For example the thickness may be set by an operator using an operator panel before the print job starts. For example, in response to the operator panel command, a printer ASIC may drive the powder distribution system to set an appropriate hole array surface area and/or carriage scanning speed. A single average layer thickness may be applied to a single print job, or various different layer thicknesses may be applied within the single print job. In one example the ASIC may vary a powder amount over a single layer based on a calculated varying thickness of a previous, partially fused, powder layer for example in order to compensate for “pits” formed by the fused portions.

The method may include supplying powder to an intermediate powder buffer reservoir using a powder delivery system (block 210). The method may include scanning the intermediate powder buffer reservoir over a build stage while heating the powder in the reservoir (block 220). In different examples the powder in the reservoir may be heated using at least one of an additive manufacturing apparatus' powder bed irradiation structure or dedicated heater elements in the powder distribution system. The method may include distributing powder from the reservoir onto the stage during scanning (block 230), wherein the powder flows out of the reservoir during scanning. In one example a ridged or grooved distributor roller is used to distribute the powder over the stage. The powder may flow from the reservoir directly onto the stage, or the powder may flow from the reservoir onto a distributor and from the distributor onto the stage. The hole array hole sizes in the reservoir may be set to allow for even and controlled dosing. The method may include further distribution and/or flattening of the powder over the stage using at least one of a distribution roller and flattening roller (block 240). Other distribution structures or flattening structures may be used, such as squeegees. In one example flattening may be limited or omitted to obtain a ridged layer surface profile so that more powder surface is directly exposed to radiation as compared to a flat surface. In some examples a ridged layer surface profile may even double the layer surface as compared to a flat layer.

What is claimed is:

1. A powder distribution system for use in an additive manufacturing apparatus, comprising
a carriage to scan over a build stage,
an intermediate powder buffer on the carriage to receive powder from a powder delivery system of the additive manufacturing apparatus,
a distributor on the carriage to distribute powder from the intermediate powder buffer over the build stage.

2. The powder distribution system of claim 1 wherein
the carriage is to scan in two opposite directions across the stage to be able to distribute powder over the stage in both directions, and
the intermediate powder buffer is to provide powder to two opposite sides of the distributor to facilitate distributing the powder in both directions.

3. The powder distribution system of claim 1 wherein the powder buffer includes a reservoir with a hole array plate in its bottom to allow powder to pass through towards the stage.

4. The powder distribution system of claim 3 wherein the powder buffer includes a structure for varying a size of holes of the hole array plate.

5. The powder distribution system of claim 4 wherein
the hole array plate includes different hole arrays having holes of different diameters, wherein within each hole the holes have the same diameter, and
a shutter to shut holes of at least one array.

6. The powder distribution system of claim 3 wherein the powder buffer includes a shake element to shake the plate to facilitate relatively constant powder flow through the holes.

7. The powder distribution system of claim 1 wherein the intermediate powder buffer is to provide the powder to the distributor so that the distributor distributes the powder from the buffer over the stage.

8. The powder distribution system of claim 3 wherein the distributor extends under the reservoir to
receive powder passing through the hole array, and
distribute the powder over the stage.

9. The powder distribution system of claim 1 wherein
the intermediate powder buffer is to provide the powder to the stage, and
the distributor further spreads the powder over the stage.

10. The powder distribution system of claim 1 wherein the distributor comprises a roller.

11. The powder distribution system of claim 10 wherein the roller includes ridges and/or grooves parallel to its central axis to facilitate even distribution of the powder from the buffer.

12. The powder distribution system of claim 1 wherein the distributor comprises
a roller to distribute powder from the buffer over the stage, and
a flattening roller to flatten distributed powder.

13. The powder distribution system of claim 1 comprising a pre-heater element in at least one of the powder buffer and the distributor.

14. An additive manufacturing sub-system for an additive manufacturing apparatus, comprising
a powder distribution system of claim 1, and
at least one irradiation structure that, during carriage scanning, heats powder in the powder buffer before distribution on the powder bed.

15. A method of distributing powder over a stage comprising
supplying powder to an intermediate buffer reservoir,
scanning the intermediate buffer reservoir over the stage, and
distributing powder from the reservoir onto the stage during scanning.
